(19) United States
(12) Patent Application Publication
(10) Pub. No.: US 2008/0293405 A1
(43) Pub. Date: Nov. 27, 2008

(54) SYSTEM AND METHOD FOR ADAPTIVE ROAMING

(76) Inventor: David MEYER, East Meadow, NY (US)

Correspondence Address: FAY KAPLUN & MARCIN, LLP, 150 BROADWAY, SUITE 702, NEW YORK, NY, 10038, US

(21) Appl. No.: 11/753,300

(22) Filed: May 24, 2007

(51) Int. Cl. H04Q 7/20

(52) U.S. Cl. 455/432.1

(57) ABSTRACT

Described is a system and method for adaptive roaming. The system may include a memory storing at least one roaming parameter. The at least one roaming parameter corresponds to a performance of a mobile unit roaming within a network that includes a plurality of access points. The system also includes a processor incorporating the roaming parameter into a learning algorithm. The learning algorithm provides the mobile unit with a scan list indicating an order to scan the plurality of access points. The learning algorithm is stored in the memory. Roaming data gathered when the mobile unit roams within the network is used by the processor to update the at least one roaming parameter so that the learning algorithm may be adjusted thereby.

### FIELD OF THE INVENTION

The present invention relates generally to a system and method for adaptive roaming of mobile devices. Specifically, mobile devices utilize a learning method to predict potential areas to which the mobile device may roam and modify thresholds related to roaming.

### BACKGROUND

When a mobile unit (MU) terminates communication with a first access point (AP) and initiates communication with a second AP, it is commonly referred to as a roam. In a roam, the MU scans all available radio frequency channels in order to reconnect to a network including the first and second APs. For example, the MU may perform the scan to find an AP that is providing a best signal strength. The MU performs an association/authentication handshake and begins transmitting/receiving packets with the selected AP. The time it takes the MU to scan and associate with the selected AP may be problematic if the MU was conducting a voice application (e.g., mobile phone, walkie-talkie) when the roam occurred. The roam may cause the MU to drop voice packets or the call because the wireless connection is being transferred to the selected AP.

In order to reduce the time it takes for the MU to scan and associate with the selected AP, roaming algorithms are used to establish thresholds for certain parameters. These parameters may include, for example, a minimal connection strength. Thus, if the connection strength to the first AP drops below the minimal connection strength, the MU may prepare for a roam. However, the thresholds are “hard coded” into the processor so that other factors such as antenna type, environment conditions, etc. are not taken into consideration. Consequently, the thresholds may be optimal in one environment but may be detrimental in other environments such as when the MU roams frequently or infrequently. Other measurable factors may be measured and used to reduce the amount of roaming time. However, with the “hard coded” thresholds, these other measurable factors are often ignored.

### SUMMARY OF THE INVENTION

The present invention relates to a system and method for adaptive roaming. The system may include a memory storing at least one roaming parameter. The at least one roaming parameter corresponds to a performance of a mobile unit roaming within a network that includes a plurality of access points. The system also includes a processor incorporating the roaming parameter into a learning algorithm. The learning algorithm provides the mobile unit with a scan list indicating an order to scan the plurality of access points. The learning algorithm is stored in the memory. Roaming data gathered when the mobile unit roams within the network is used by the processor to update the at least one roaming parameter so that the learning algorithm may be adjusted thereby.

### DESCRIPTION OF THE DRAWINGS

FIG. 1 shows an exemplary system of an access point with neighboring access points according to the present invention.

FIG. 2 shows a flow diagram of an exemplary method of adaptive roaming according to the present invention.

FIG. 3a shows a first anticipative roaming prediction table according to an exemplary embodiment of the present invention.

FIG. 3b shows a second anticipative roaming prediction table according to an exemplary embodiment of the present invention.

FIG. 3c shows a third anticipative roaming prediction table according to an exemplary embodiment of the present invention.

### DETAILED DESCRIPTION

The present invention may be further understood with reference to the following description and the appended drawings, wherein like elements are referred to with the same reference numerals. The present invention describes a system and method to enable a mobile unit (MU) to roam in an adaptive manner. According to the exemplary embodiments of the present invention, a learning algorithm updates factors related to a roaming of the MU. According to further exemplary embodiments of the present invention, an anticipative roaming prediction table is updated so that based on prior connections, the MU may predict an access point to which it may roam. The learning algorithm, factors, and anticipative roaming prediction table will be discussed in detail below.

A wireless communication network incorporates access points (AP) to extend a coverage area so that a MU may connect to the network in a greater number of locations. The APs contain an individual coverage area that is a part of the coverage area of the network. Once the MU is wirelessly connected to an AP, the MU may communicate with the network while traveling within the coverage area of the AP. As the MU exits the coverage area of the AP, the MU may have to switch connection to a neighboring AP to maintain the connection to the network (i.e., roam). The time necessary to switch from one AP to another AP may determine the continuity of the MU maintaining the connection to the network.

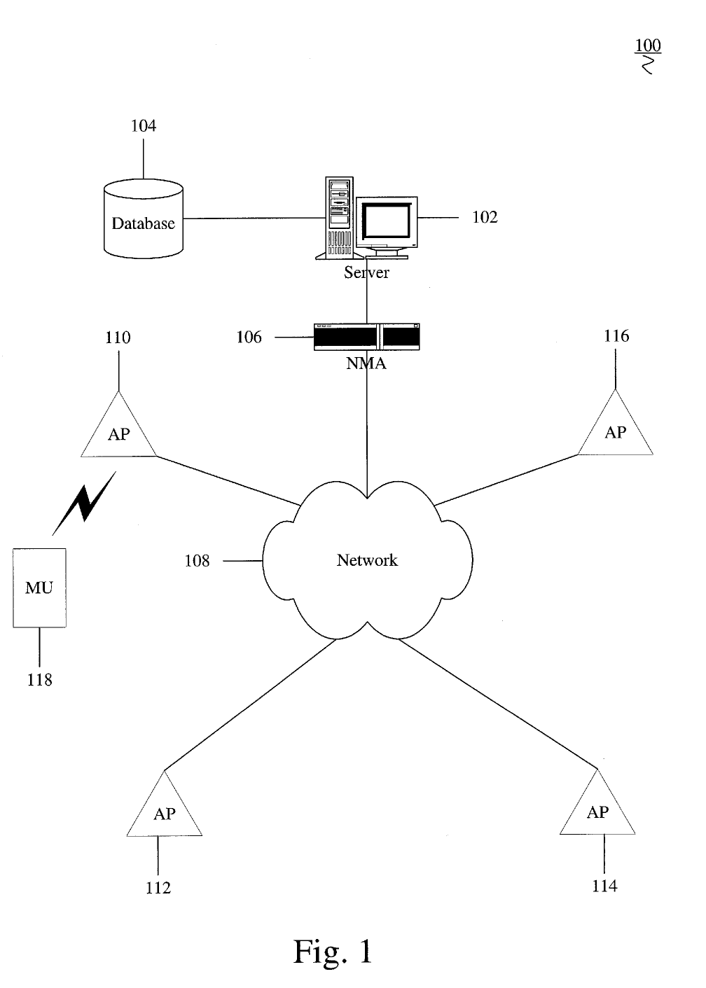

FIG. 1 shows a system 100 which includes access points 110-116 according to an exemplary embodiment of the present invention. A server 102 may be connected to a network 108. The server 102 may further be connected to a database 104. A network management arrangement (NMA) 106 may be connected to the network 108. It should be noted that the NMA disposed between the server 102 and the network 108 is only exemplary. Those skilled in the art will understand that the server 102 may be directly connected to the network 108. The APs 110-116 may be connected to the network 108 using hard-wiring, wireless connectivity, or a combination thereof. Those skilled in the art will also understand that each of the APs 110-116 may be connected to a different NMA, may operate under the same NMA 106, or the system may not include the NMA 106. According to the exemplary embodiment, a MU 118 communicates with the AP 110 and may roam to the coverage areas of any of the APs 112-116. The MU 118 may include a memory functioning substantially similar to the database 104 for the server 102. For example, the memory of the MU 118 may store data and/or programs pertaining to the various functionalities in which the MU 118 is equipped. The memory of the MU 118 may also store the learning algorithm and/or the anticipative roaming prediction table.

It should be noted that the system shown in FIG. 1 is only exemplary and there may be fewer or more APs and the MU 118 may be initially communicating with any of the APs 112-116. In the exemplary embodiment, each of the APs 112-116 includes a coverage area that may overlap or be adjacent to the coverage area of the AP 110. Thus, when the MU 118 roams from the AP 110, it may enter the coverage area of any of the APs 112-116. However, it should be noted that the coverage areas of the APs may be discontinuous. That is, for example, the coverage area of the AP 110 and the AP 116 may include a gap. Thus, if the MU 118 disconnects from the AP 110 and enters the AP 116, a down time (i.e., time when the MU 118 is not in communication with the network 108) may exist. The present invention may include this scenario where a gap in coverage area is incorporated into the learning algorithm.

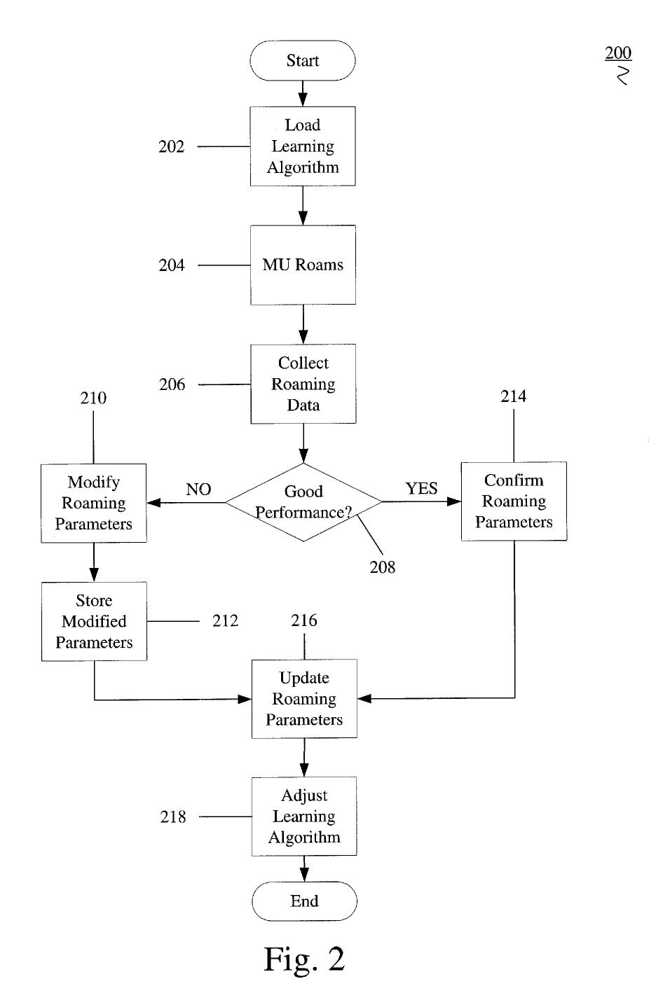

In one exemplary embodiment, the learning algorithm may be updated and stored on the database 104 of the server 102 or in the NMA 106. In another exemplary embodiment, each of the APs 110-116 includes a memory that stores the learning algorithm that may be used by the mobile units disposed within the network 108 (e.g., MU 118). That is, in either embodiment, all components of the system 100 that are connected to the network 108 may access the learning algorithm. Thus, before the MU 118 traverses the coverage area of AP 110 into a coverage area of another AP (e.g., APs 112-116), the learning algorithm may be used by the MU 118 to efficiently transfer connection (i.e., associate) from the AP 110 to one of the APs 112-116. In yet another exemplary embodiment, each MU may store a respective learning algorithm in its memory so that the MU may utilize the learning algorithm to execute a roam. The learning algorithm will be discussed in further detail below with reference to the method of FIG. 2.

The learning algorithm may include various parameters affecting a roam of the MU 118. For example, the parameters may include signal strength, noise level, bandwidth, length of time to roam, time since previous roam, etc. That is, the learning algorithm may process one or more parameters (such as those listed above) to execute a roam. The values of the parameters may initially be stored, for example, in the database 104, the NMA 106, the memory of the MU 118, or a combination thereof. These values may be measured values from the MU 118 performing roams. Initial values may also be stored in the case where the MU 118 has not performed any roams. Depending on the manner in which the learning algorithm performs, the values of the parameters may be stored and deleted upon an update of the learning algorithm. For example, if the learning algorithm continuously runs and updates when a new value of a parameter is inputted, the new value may automatically be incorporated into the learning algorithm, and the previous value for the parameter may be deleted.

In another example, the learning algorithm may run and update at predetermined time periods, such as every hour, upon activating the MU, etc. In yet another example, upon sufficient data being gathered, new thresholds may be deployed to the MU 118. The new thresholds may be determined in a variety of manners depending on how the learning algorithm performs. For example, if the learning algorithm is stored on the database 104, the new thresholds may be calculated by the server 102 and transmitted to the MU 118. In another example, if the learning algorithm is stored on the memory of the MU 118, the new thresholds may be calculated by the MU 118 and stored in the memory. New values of parameters may be saved and subsequently loaded to be incorporated into the learning algorithm. It should be noted that the values of the parameters may be stored indefinitely depending on, for example, a size of the memory of the MU, the database 104, etc. It should also be noted that the values of the parameters may be regularly deleted upon storing after a predetermined time period (e.g., one month, six months, one year, etc.).

The parameters affecting a roam may be used to, for example, modify thresholds associated with the roam. Initial threshold values may be coded into the learning algorithm as defaults. The initial threshold values may be, for example, an industry standard, common threshold values, etc. Thus, when the MU 118 has not determined any values for the above-mentioned parameters (i.e., has not experienced a roam to record values) (e.g., first activation of the MU 118), the MU 118 may refer to the initial threshold values when deciding whether to roam. Once the MU 118 performs a roam, values for these parameters may be measured or calculated, depending on the location in which the learning algorithm is stored (e.g., MU 118, server 102). The learning algorithm may subsequently adjust the initial threshold values to create modified threshold values based on these parameter values. These modified threshold values may apply to an individual MU (e.g., MU 118) or may apply to the MUs disposed within the network 108. For example, if the server 102 incorporates parameter values for all MUs disposed in the network 108, the modified values may apply to all the MUs.

In another example, if the MU 118 incorporates its own parameter values, the modified values may apply to only the MU 118. It should be noted that if the MUs disposed within the network 108 use a variety of hardware devices such as antenna, then individual modified threshold values corresponding to the respective MU may be preferable. Furthermore, even if the MUs disposed within the network 108 utilize common hardware devices, ambient conditions may affect connectivity to the network 108. In such a scenario, individual modified threshold values may also be preferable.

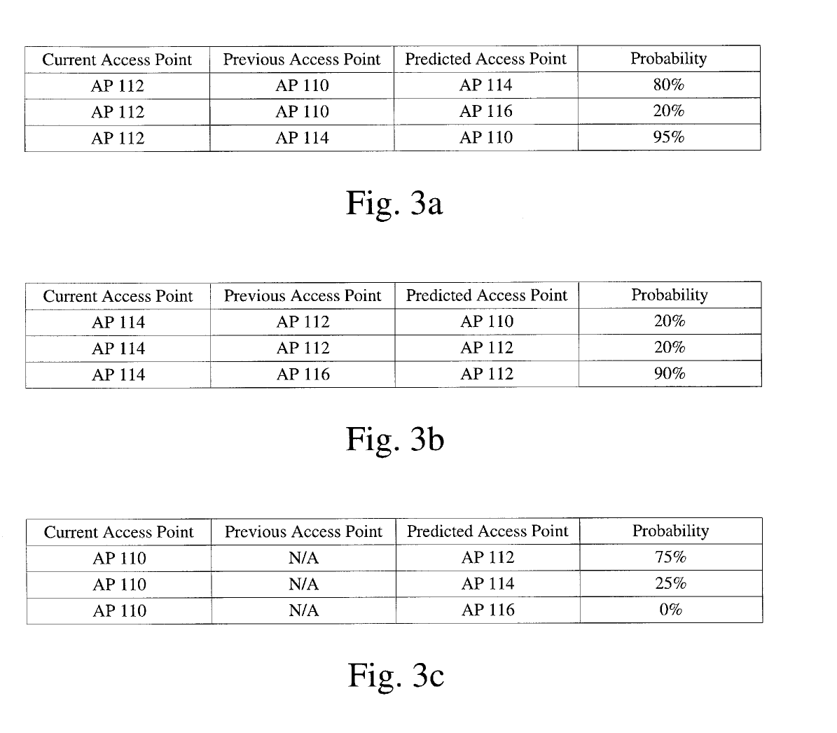

Furthermore, the learning algorithm may include the anticipative roaming prediction table. The anticipative roaming prediction table may utilize, for example, a “handoff history.” A “handoff history” refers to the number of times an association/authentication with any MU (or a particular MU) switches from one AP to another AP in the network. The handoff history may be stored in the database 104, the memory of the MU 118, etc. The anticipative roaming prediction table will be discussed in more detail below and with reference to the tables of FIGS. 3a-c.

In a first exemplary embodiment, the handoff history may be collected for the entire network 108. For example, the handoff history between AP 110 and AP 112 may include the total number of times that any MU disposed in the network 108 roamed from AP 110 to AP 112. In another embodiment, the handoff history may be collected for a particular MU. For example, the handoff history for the MU 118 may be for traversing the coverage area of the AP 110 to the coverage areas of other APs (e.g., APs 112-116). In either embodiment, the handoff history may be segmented for an entire active period, specific times of the day, in a given time period, etc. The handoff history may be based from a first connection to the network 108, a first connection on a particular day, etc. In other examples, the handoff history may be separated by time of year (e.g., months, seasons, etc.) or time of day (e.g., morning, afternoon, etc.).

As discussed above, the handoff history may be based on other data. Thus, the handoff history may be supplemented using data such as signal strength (RSSI). As will be described in greater detail below with reference to FIGS. 3a-c, the handoff history may be used to ultimately create a scan list of APs for the MU 118 when the MU 118 needs to roam. The supplemental data (e.g., RSSI data) may be used to modify the scan order determined based on only the handoff history. For example, based on the handoff history alone, the scan list for the MU 118 leaving the coverage area of AP 110 may be AP 112, AP 114, and AP 116. However, the MU 118 may measure the RSSI of each of the APs 112-116 and modify the scan list by using the supplemental data (e.g., RSSI data). For example, the signal received from AP 114 may have a RSSI that is 50% greater than the RSSI of the signal received from the AP 112. Thus, the MU 118 may modify the scan list to include the channel for the AP 114 prior to the AP 112.

FIGS. 3a-c show anticipative roaming prediction tables according to an exemplary embodiment of the present invention. The tables of FIGS. 3a-c will be described with reference to the system 100 of FIG. 1. FIGS. 3a-c include columns indicating a current access point, a previous access point, a predicted access point, and a probability. The column of current access points refers to the access point to which the MU 118 is currently connected. The column of previous access points refers to the access point that the MU 118 was previously connected prior to roaming into the current access point. The column of predicted access points refers to the access point that the MU 118 may roam. The column of probabilities refers to a likelihood that the MU 118 will roam into the coverage area of the predicted access point, given the current access point and the previous access point.

For example, in the first table of FIG. 3a, the MU 118 has a current access point of AP 112. That is, the MU 118 is connected to the network 108 via the AP 112. The MU 118 is likely to be in the coverage area of the AP 112. However, it should be noted that the MU 118 may be in a coverage area of another AP but maintains a stronger connectivity with the AP 112. The first row of the table of FIG. 3a indicates that the MU 118 was previously connected to the AP 110 and has subsequently roamed so that the MU 118 is currently connected to the AP 112.

The first row further indicates that the probability of the MU 118 subsequently roaming from the AP 112 to the AP 114 is 80%. The 80% probability may be calculated using a variety of methods. For example, an algorithm may consider a first sum of the number of roams the MU 118 has experienced from a particular previous access point (e.g., AP 110) to a particular current access point (e.g., AP 112) to any subsequent access point (i.e., predicted access point) (e.g., APs 110, 114, 116). That is, the previous access point and the current access point are the same for each addend of the first sum. A second sum may be found for the number of times that the MU 118 roamed into a particular predicted access point. (If the first sum includes 10 addends, 8 of those addends may pertain to the MU 118 roaming into the predicted access point 114.) That is, a portion of the first sum is the second sum. Taking a ratio of the second sum to the first sum, a probability value may be ascertained. (Given 10 addends, 8 of which is for the prediction access point 114, 8/10 yields an 80% probability.)

It should be noted that the above algorithm may be altered to incorporate the factors affecting a roam discussed above. For example, upon finding a first probability using the steps described above, signal strength values may be used to further determine the probability. That is, if a predicted access point has a high signal strength, the probability may be increased while if a predicted access point has a low signal strength, the probability may be decreased. Other examples may include topology data (e.g., locations of the APs within the network), time of roam, time since previous roam, etc.

As further shown by the first table in FIG. 3a, the second row indicates that the probability that an MU 118 that has already roamed from the AP 110 (i.e., previous access point) to the AP 112 (i.e., current access point) will next roam to the AP 116 (i.e., predicted access point) is 20%. The third row indicates that the probability of an MU 118 that has roamed from the AP 114 (i.e., previous access point) to the AP 112 (i.e., current access point) will next roam to the AP 110 (i.e., predicted access point) is 95%.

As shown in the second table of FIG. 3b, the first row indicates that the probability of the MU 118 roaming to the AP 110 (i.e., predicted access point) after having gone from the AP 112 (i.e., previous access point) to the AP 114 (i.e., current access point) is 20%. The second row indicates that the probability of the MU 118 roaming back to the AP 112 (i.e., predicted access point) after having initially started at the AP 112 (i.e., previous access point) and moved to the AP 114 (i.e., current access point) is 20%. That is, the table of FIG. 3b also calculates probabilities of the MU 118 returning to an access point, unlike the rows of the first table of FIG. 3a denoting a roaming path that does not return to a previous access point. The third row indicates that the probability of the MU 118 roaming from the AP 116 (i.e., previous access point) to the AP 114 (i.e., current access point) to the AP 112 (i.e., predicted access point) is 90%.

As shown in the third table of FIG. 3c, the first row indicates that there is no previous access point for the MU 118. Such a scenario may arise when the current access point is the first access point to which the MU 118 has connected. That is, the table of FIG. 3c also calculates probabilities of the MU 118 upon an initial connection to the network 108 unlike the first and second tables of FIGS. 3a, b, respectively, which show probabilities where a previous access point exists. Therefore, in the third table, the probability of the MU 118 roaming from the AP 110 (i.e., current access point) to the AP 112 (i.e., predicted access point) is 75%. The second row indicates that the probability of the MU 118 roaming from the AP 110 (i.e., current access point) to the AP 114 (i.e., predicted access point) is 25%. The third row indicates that the probability of the MU 118 roaming from the AP 110 (i.e., current access point) to the AP 116 (i.e., predicted access point) is 0%. The probability may be calculated in a variety of manners using, for example, previously recorded roaming data. The calculations may be done substantially similar to that performed with reference to the table of FIG. 3a. Taking a first sum of the number of times the MU 118 has connected to the current access point (e.g., MU connected to AP 110 four times), a ratio is found using a second sum of the number of times the MU 118 roamed to a specific predicted access point (e.g., MU 118 roamed to subsequently connect to AP 112 three times, thereby making a 3:4 ratio, resulting in a 75% probability).

Using the first, second, and third tables, the learning algorithm may create a scan list for the MU 118 prior to a roam in order to decrease the amount of time necessary to associate/authenticate with a subsequent AP. The scan list may simply order the APs according to their assigned probabilities in descending order. For example, according to the first table, the MU 118 may attempt to roam to AP 114 prior to attempting a roam to AP 116. It should be noted that the scan list may be created using only probabilities where the previous access point and the current access point are in common (e.g., first and second rows of the first table). In another example, according to the second table, the probabilities that the MU 118 will roam to AP 110 or AP 112 are the same. In such a case, the MU 118 may consider other factors affecting a roam. The MU 118 may also consider the most recent roam with a given previous access point and current access point. That is, if the MU 118 had roamed from the AP 112 to the AP 114 to the AP 110 (i.e., first row of the second table) more recently than a roam from the AP 112 to the AP 114 to the AP 112 (i.e., second row of the second table), then the MU 118 may place the first row over the second row when compiling the scan list.

It should be noted that the first, second, and third tables existing as separate databases is only exemplary. The learning algorithm may store the anticipative roaming prediction tables as one large database. As discussed above, the one database may involve, for example, all the MUs disposed in the network 108, a single MU disposed in the network 108, etc.

FIG. 2 shows an exemplary method 200 of adaptive roaming according to the present invention. The method 200 will be described with reference to the system 100 of FIG. 1 and the first, second, and third tables of FIGS. 3a-c, respectively. The method 200 incorporates the learning algorithm so that when the MU 118 attempts a roam, the learning algorithm may dictate the manner in which to roam such as by using a scan list.

In step 202, the learning algorithm is loaded. As discussed above, the learning algorithm may be implemented in a variety of manners. For example, the learning algorithm may be stored on the database 104. Thus, in order for the learning algorithm to be loaded, the MU 118 first contacts the server 102 that it is preparing to roam. The learning algorithm may be retrieved from the database 104 by the server 102 and forwarded to the MU 118. In another example, the learning algorithm may be stored locally on a memory of the MU 118. Thus, prior to roaming, a processor retrieves the learning algorithm from the memory of the MU 118.

The learning algorithm may include the thresholds associated with the roam. As discussed above, a signal strength may indicate when a roam may occur. Thus, the MU may measure the signal strength from the AP and when this strength drops below a connection threshold, the MU may be attempting a roam. It should be noted that this data may be transmitted from the MU to the server if the learning algorithm is performed at the server. Therefore, by loading the learning algorithm prior to the MU roaming, appropriate measures may be taken so an efficient roam may take place. Furthermore, the learning algorithm provides an initial default scan list to perform the roam. That is, the scan list indicates an order to scan for APs in which the MU may roam. The scan list may be an initial list created for the MU. For example, if the MU first connects to the network 108, the initial list provides an unaltered set of APs. The scan list may also be altered if the MU has already connected to the network 108 previously. That is, the scan list may already include, for example, the anticipative roaming prediction tables, parameters affecting roam, etc.

In step 204, the MU roams. That is, the MU disconnects from a first AP and connects to a different AP by, for example, leaving a coverage area of the first AP and entering a coverage area of the different AP. As shown in the system 100, the MU 118 is currently connected to the network 108 via the AP 110 (i.e., first AP). The MU 118 may roam to, for example, the coverage area of the AP 112 and reconnect to the network 108 via the AP 112 (i.e., different AP).

In step 206, roaming data is collected. The roaming data that is collected pertains to the particular roam that is occurring for a specific MU. For example, the MU 118 may roam from the AP 110 to the AP 112. Thus, the roaming data may be data concerning this particular roam. The roaming data may include, for example, the time it takes to disconnect from the AP 110, the time it takes to connect to the AP 112, the signal strength prior to disconnection, the signal strength upon connection, location data, etc.

In step 208, a determination is made whether the roam had a good performance. A good performance may be based, for example, on the time it takes for the MU to reconnect to the network 108 via a roamed AP upon disconnecting from a current AP. If the time is below a certain threshold, a good performance indication may be provided. In contrast, if the time is above a certain threshold, a bad performance indication may be provided. Other factors may be considered to determine whether the roam had a good performance. For example, a resultant signal strength with a roamed AP may be considered (i.e., a signal strength the MU measures from an AP in which the MU connects upon a roam). Thus, if the resultant signal strength is above a threshold, then a good performance indication may be provided while a signal strength below a threshold provides a bad performance indication.

If step 208 determines a good performance, the method 200 continues to step 214. In step 214, the roaming parameters that were determined from the roaming data that was collected in step 206 are confirmed. If step 208 determines a bad performance, the method 200 continues to step 210. In step 210, the roaming parameters that were determined are modified by incorporating the roaming data that was collected in step 206. Roaming parameters may be modified in a variety of manners. For example, a roaming parameter may be signal strength. If the roaming data that was collected include a resultant signal strength (i.e., strength of signal when the MU connects to a new AP upon roaming), the resultant signal strength may be used as part of a calculation to update the signal strength parameter. That is, the signal strength parameter may be increased or decreased for subsequent roams based on the resultant signal strength that was collected. In step 212, the modified roaming parameters are stored. As discussed above, the modified roaming parameters may be stored in, for example, the database 104, a memory of the MU 118, etc.

Upon confirming the roaming parameters (i.e., step 214) or storing the modified parameters (i.e., step 212), the method continues to step 216 where the roaming parameters are updated for the learning algorithm. As discussed above, the learning algorithm may contain a database of the roaming parameters. Furthermore, the roaming parameters may be updated in a variety of manners such as continuously and periodically. Using the updated roaming parameters, in step 218, the learning algorithm is adjusted. For example, the thresholds associated with roaming may be adjusted according to the updated roaming parameters. In another example, the anticipative roaming prediction tables may be updated to include the roam that just occurred to then update the probabilities of roaming into an AP.

The above described exemplary embodiments allows for a MU to roam within a network that has APs disposed throughout. By utilizing a variety of parameters that affect a roam, a more efficient means of roaming is established by the present invention. Consequently, a time necessary for the MU to reconnect to a network after disconnecting from a first MU is decreased. The learning algorithm of the present invention also updates (e.g., continuously, periodically, or a combination thereof) to further improve on the means of roaming. Further data concerning the parameters that are gathered allow the learning algorithm to further improve upon the means of roaming. Even in situations where the MU completely disconnects from the network (e.g., leaving an operating area of the network, being located in a zone where connectivity is not possible, etc.), the learning algorithm of the present invention may use the collected data to determine a course of action. For example, a scan list may be created using a previously connected AP, relative connection strengths to other APs, etc.

Those skilled in the art will understand that the above described exemplary embodiments may be implemented in any number of manners, including, as a separate software module, as a combination of hardware and software, etc. For example, the learning algorithm may include a program containing lines of code that, when complied, may be executed on a processor of the MU 118.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
providing at least one roaming parameter, the at least one roaming parameter corresponding to a performance of a mobile unit roaming within a network, the network including a plurality of access points;
incorporating the at least one roaming parameter into a learning algorithm, the learning algorithm providing the mobile unit with a scan list, the scan list indicating an order to scan the plurality of access points;
determining roaming data when the mobile unit roams within the network;
updating the at least one roaming parameter based on the roaming data; and
adjusting the learning algorithm based on the at least one updated roaming parameter by providing an adjusted scan list to be used in a subsequent roaming operation.

2. The method of claim 1, wherein the least one roaming parameter is at least one of a signal strength, a noise level, a bandwidth, a length of time to roam, and a time since a previous roam.

3. The method of claim 1, wherein the roaming data is used to adjust a threshold for at least one of a signal strength, a noise level, a bandwidth, a length of time to roam, and a time since a previous roam.

4. The method of claim 1, wherein the updating occurs one of continuously, periodically, and a combination thereof.

5. The method of claim 1, wherein the learning algorithm includes an anticipative roaming prediction table.

6. The method of claim 5, wherein the anticipative roaming prediction table determines a probability of the mobile unit roaming to a predicted access point based on a previous access point and a current access point.

7. The method of claim 5, wherein the anticipative roaming prediction table is based on a handoff history corresponding to at the access points involved in at least one prior roam by the mobile unit.

8. The method of claim 5, further comprising:
utilizing the anticipative roaming prediction table prior to the mobile unit roaming.

9. The method of claim 1, wherein the at least one roaming parameter corresponds to a threshold indicating that the mobile unit is prepared to roam.

10. The method of claim 1, wherein the learning algorithm applies one of only to a single mobile unit, at least two mobile units disposed within the network, and all mobile units disposed within the network.

11. The method of claim 1, wherein the learning algorithm includes an initial scan list, the initial scan list being used for a first roam that the mobile unit performs in the network.

12. A system, comprising:
a memory storing at least one roaming parameter, the at least one roaming parameter corresponding to a performance of a mobile unit roaming within a network that includes a plurality of access points; and
a processor incorporating the roaming parameter into a learning algorithm, the learning algorithm providing the mobile unit with a scan list indicating an order to scan the plurality of access points, the learning algorithm being stored in the memory,
wherein roaming data gathered when the mobile unit roams within the network is used by the processor to update the at least one roaming parameter so that the learning algorithm may be adjusted thereby.

13. The system of claim 12, wherein the least one roaming parameter corresponds to at least one of a signal strength, a noise level, a bandwidth, a length of time to roam, and a time since a previous roam.

14. The system of claim 12, wherein the roaming data is used to adjust a threshold for at least one of a signal strength, a noise level, a bandwidth, a length of time to roam, and a time since a previous roam.

15. The system of claim 12, wherein the processor updates one of continuously, periodically, and a combination thereof.

16. The system of claim 12, wherein the learning algorithm includes an anticipative roaming prediction table.

17. The system of claim 16, wherein the anticipative roaming prediction table determines a probability of the mobile unit roaming to a predicted access point based on a previous access point and a current access point.

18. The system of claim 16, wherein a content of the anticipative roaming prediction table is based on a handoff history corresponding to the access points involved in at least one prior roam by the mobile unit.

19. The system of claim 12, wherein the at least one roaming parameter corresponds to a threshold so that the processor may determine if the mobile unit is prepared to roam.

20. A computer readable storage medium including a set of instructions executable by a processor, the set of instructions operable to:
provide at least one roaming parameter, the at least one roaming parameter corresponding to a performance of a mobile unit roaming within a network, the network including a plurality of access points;
incorporate the at least one roaming parameter into a learning algorithm, the learning algorithm providing the mobile unit with a scan list, the scan list indicating an order to scan the plurality of access points;
determine roaming data when the mobile unit roams within the network;
update the at least one roaming parameter based on the roaming data; and
adjust the learning algorithm based on the at least one updated roaming parameter by providing an adjusted scan list to be used in a subsequent roaming operation.

21. A method, comprising:
determining roaming data for a mobile unit in a roaming operation;
providing the roaming data to a learning algorithm; and
executing the learning algorithm to provide a scan list based on the roaming data, the scan list indicating an order to scan a plurality of access points.
